(19) United States
(12) Patent Application Publication
(10) Pub. No.: US 2024/0267467 A1
(43) Pub. Date: Aug. 8, 2024

(54) METHOD FOR ORGANIZING A CONVERSATION VIA MOBILE RADIO, AND MOTOR VEHICLE

(71) Applicant: AUDI AG, Ingolstadt (DE)

(72) Inventors: Sebastian HANRIEDER, Königsmoos (DE); Benjamin POPPINGA, Wettstetten (DE); Florian SCHWENSFEIER, Oberhausen an der Donau (DE); Simon SEITLE, Oberhausen (DE)

(73) Assignee: AUDI AG, Ingolstadt (DE)

(21) Appl. No.: 18/419,928

(22) Filed: Jan. 23, 2024

(30) Foreign Application Priority Data
Feb. 3, 2023 (DE) 102023102662.3

(51) Int. Cl. H04M 3/56; B60W 40/08; B60W 50/00; G01C 21/34; H04M 1/60

(52) U.S. Cl. CPC H04M 3/565; B60W 40/08; B60W 50/0097; G01C 21/3492; H04M 1/6091; B60W 2540/22

(57) ABSTRACT

A driving situation complexity is determined in a motor vehicle in order to schedule a telephone call made by the vehicle driver or other vehicle occupant in advance and to transmit corresponding indications to a possible caller.

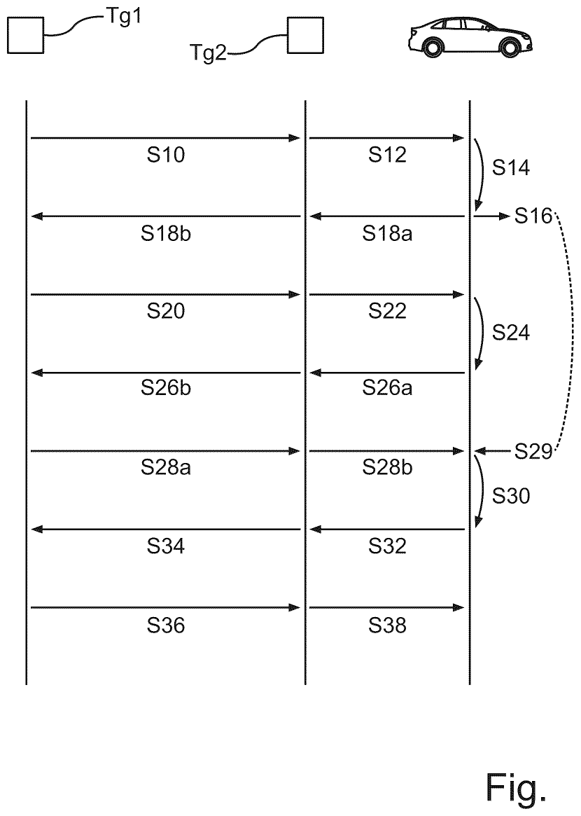

### FIELD

The invention relates to a method for organizing a conversation via mobile radio between a calling subscriber and a subscriber to be called, wherein the subscriber to be called is located in a motor vehicle, in particular as a vehicle driver, and wherein the calling subscriber uses a first subscriber device and the subscriber to be called uses a second subscriber device. The second subscriber device can be designed as a mobile telephone, smartphone, tablet computer, etc. carried by the subscriber to be called, but it can also be integrated into the motor vehicle (installed SIM card with associated control device apparatus).

### BACKGROUND

It is known that incoming telephone calls in a motor vehicle are rejected when the driver is under high stress. EP 1 513 326 A1 describes such handling of an incoming call in or by a motor vehicle. DE 102 26 425 A1 also relates to the answering of calls, wherein the driving situation is checked to see whether the answering can take place within a predetermined time.

Furthermore, it is known to inform the caller. EP 1 524 833 B1 describes that a corresponding message is sent to the caller by the motor vehicle in which a hands-free device is activated. DE 60 210 164 T2 discloses sending a response message by the motor vehicle to a call if answering the call is dangerous. Information about the vehicle (navigation data) may also be transmitted in this case.

DE 69 808 947 T2 describes determining the activity status of the motor vehicle and sending a waiting message to the caller until a driver's safety status is reached.

The disadvantage of the prior art is that, although the driver of the motor vehicle is protected from having to make a telephone call in an adverse situation, the need of the caller to place the call as soon as possible, on the one hand, and the need of the vehicle occupant, who would also like to receive the call under the most favorable conditions, are neglected.

### SUMMARY

Accordingly, it is the object of the invention to show a way in which safety interests can be reconciled with the interest of both participants in performing the telephone call as soon as possible.

The method for organizing a conversation via mobile radio between a calling subscriber and a subscriber to be called, wherein the subscriber to be called is in a motor vehicle, in particular as a vehicle driver, and wherein the calling subscriber uses a first subscriber device and the subscriber to be called uses a second subscriber device, comprises the following steps:
receiving a conversation request sent from the first subscriber device by the second subscriber device;
determining, by the motor vehicle, first information that is necessary to determine a current driving situation complexity and second information that is necessary to determine a future driving situation complexity;
using at least the second information and optionally also the first information to determine a possible call time or an interval in which a call can be started;
transmitting an indication regarding the possible call time or the interval to a scheduling unit of the first subscriber device.

The invention introduces the concept of scheduling calls and thus goes far beyond the prior art, in which incoming calls are simply blocked or delayed. In this way, modern requirements can be taken into account, whereby vehicle drivers and other vehicle occupants want to use the time spent in the car for telephone calls and video conferences and the like.

According to an advantageous embodiment of the invention, the motor vehicle transmits the first and second information to the second subscriber device (located therein), in which subscriber device a data processing device then carries out the step of using the at least second information and optionally also the first information and wherein the second subscriber device wirelessly sends the information (about the possible call time or interval) to the first subscriber device.

By using a data processing device in the second subscriber device, it is possible to use its increased computing capacity, which may not be available or not to the same extent in another control device of the motor vehicle. As the motor vehicle ages, the computing capacity can be expanded by adding a more modern subscriber device.

Alternatively, it would be possible to send the first and/or second information further to the first subscriber device, in which the computing task is then carried out outside the motor vehicle in order to determine the indication about the possible call time or interval. The scheduling unit of the first subscriber device then receives the indication within the same device.

According to a further preferred embodiment of the invention, the second information relates to the driving situation complexity during a scheduled conversation duration. The “future” driving complexity in the wording of the claim is thus ideally understood not only to mean said driving complexity at a single future point in time, but also at a plurality of future points in time within the scheduled duration of the conversation. It goes without saying that the scheduled conversation duration moves backwards (or forwards) in time, if the possible call time is moved backwards (or also forwards) in time. For example, with a scheduled conversation duration of ten minutes after an initial determination of the possible call time in one minute after receiving the conversation request, the second information can refer to the time from one minute to eleven minutes after receiving the conversation request, and the driving situation complexity can be predicted in half-minute intervals, namely for one minute, one and a half minutes, two minutes, two and a half minutes, three minutes etc. after receiving the conversation request. Other timings are of course conceivable (shorter: approximately ten-second intervals; longer: one-minute intervals; and the like).

According to a further preferred embodiment, an indication about a desired conversation duration is received with the conversation request and this indication is also used in the step of using the at least second and optionally first information. The possible call time can also vary, depending on how long the conversation could or should last. It could be possible that a three-minute long conversation could be held after one minute. However, a ten-minute conversation should only begin after five minutes.

An advantageous development of this embodiment is that an indication about an actually possible conversation duration, which optionally includes the provision of interruptions which are predefined or performed according to certain criteria, is transmitted to the scheduling unit of the first subscriber device.

This means that the person calling can already plan how long they can have the conversation. If the actual possible duration of the conversation is shorter than the desired duration, the person has to shorten the entire conversation a bit. If the actual possible duration of the conversation is identical to the desired duration, the conversation can take place as scheduled. If the actual possible duration of the conversation is even longer than the desired duration, the person calling may be able to take their time.

According to an advantageous embodiment of the invention, an indication about the conversation complexity is received with the conversation request, and this indication is also used in the step of using the at least second and optionally also first information.

Since the first and second information relate to the driving situation complexity, it is clear that when the conversation complexity is increased, the driving situation complexity must be lower than if the vehicle driver is only supposed to chat when the driving situation complexity is high.

According to an advantageous development, the motor vehicle or the second subscriber device receives an input for setting a limit for the conversation complexity, and this limit is taken into account when setting. The driver can therefore enter what is required from him while driving. When determining the possible call time and/or the interval with call times and/or when determining the duration of the conversation, this can be important so that the driver's desires can be responded to flexibly.

According to a further preferred embodiment, the first information relates to a position of the motor vehicle, a traffic density around the motor vehicle, the familiarity of the route traveled by the subscriber to be called, a stress level of the subscriber to be called measured by interior sensors of the motor vehicle, data measured by external sensors, equipment features of the motor vehicle, the occupancy of seats in the motor vehicle and/or an indication about telephone calls made by other subscribers in the motor vehicle. This therefore indicates how the motor vehicle moves through its surroundings and what stress level is directly measured in it or what influencing factors can contribute to the stress level (other subscribers, other vehicle occupants who may be on the phone).

According to a further preferred embodiment, the second information relates to a navigation route provided by the motor vehicle, a traffic density on this navigation route and/or on alternative navigation routes, information about other vehicle occupants in the motor vehicle and telephone calls made and/or scheduled by other vehicle occupants.

This second piece of information serves an attempt to predict as much as possible about the future driving situation complexity. If there is a high traffic density on the scheduled navigation route, a high level of stress is predicted for the driver. If necessary, an alternative navigation route (detours lasting up to ten minutes) can be preferred and the vehicle can be rerouted as part of the scheduling of the conversation.

According to a further preferred embodiment of the invention, a call is made from the first subscriber device to the second subscriber device, and it is continuously checked, in particular by the motor vehicle, whether the requirements for a telephone call continue to exist (namely. whether a driving situation complexity exceeds a certain threshold value, which is determined by a possibly specified conversation complexity, conversation duration, etc.). Corresponding information is transmitted to the scheduling unit or to an output device (display, etc.) of the first subscriber device. In this way, the caller is periodically informed whether the conversation can continue as scheduled or whether it needs to be interrupted or shortened.

The motor vehicle according to the invention comprises sensors and an evaluation device for detecting a current driving situation complexity as well as a navigation device. The evaluation device of the motor vehicle is designed to determine a future driving situation complexity based on navigation data in the navigation device and, depending on this, to plan in advance the receipt of a telephone or video call.

This applies in particular to the embodiment in which the motor vehicle influences the scheduling of the telephone call, video call or the like while driving, by temporarily interrupting the conversation or planning a different navigation route and the like.

For applications or usage situations that can arise in the method and which are not explicitly described here, it can be provided according to the method, that an error message and/or a request for input of user feedback is output and/or a standard setting and/or a predetermined initial status are set.

The invention also includes the control device for the motor vehicle. The control device can have a data processing device or a processor device which is configured to carry out an embodiment of the method according to the invention. The processor device can be designed as or include a CPU (“central processing unit”) and/or a GPU (“graphics processing unit”). The processor device can also have at least one microprocessor and/or at least one microcontroller and/or at least one FPGA (Field Programmable Gate Array) and/or at least one DSP (Digital Signal Processor). Furthermore, the processor device can have program code which is configured to carry out the embodiment of the method according to the invention when it is executed by the processor device. The program code can be stored in a data memory of the processor device. The processor device can be based, for example, on at least one circuit board and/or at least one SoC (System on Chip).

The invention also includes developments of the motor vehicle according to the invention, which have features as already described in the context of the developments of the method according to the invention. For this reason, the corresponding developments of the method according to the invention are not described again here.

The motor vehicle according to the invention is preferably designed as an automobile, in particular as a passenger car or truck, or as a passenger bus or motorcycle.

As a further solution, the invention also comprises a computer-readable storage medium, comprising program code which, when executed by a computer or a computer network, cause it to carry out an embodiment of the method according to the invention. The storage medium can be provided, for example, at least partially as a non-volatile data memory (such as a flash memory and/or as an SSD—solid state drive) and/or at least partially as a volatile data memory (such as a RAM—random access memory). The storage medium can be arranged in the computer or computer network. However, the storage medium can also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (such as C) and/or as a program script (such as Python).

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURE

Exemplary embodiments of the invention are described hereinafter. The only FIGURE represents steps of an embodiment of the method according to the invention involving all telephone calls.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the FIGURES, same reference numerals respectively designate elements that have the same function.

The invention is about carrying out and preemptively organizing a telephone call and other conversation (video calls or the like) originating from a first subscriber device Tg1 to a second subscriber device Tg2, which is located in a motor vehicle. The subscriber device Tg2 can in particular be carried as a smartphone by a driver of the motor vehicle, or it can be fixedly installed in the motor vehicle. While the method according to the invention has been described above from the perspective of the subscriber device Tg2, possibly in connection with the motor vehicle, and is also reproduced in a corresponding form in the claims, the overall method containing the invention can be fully described if the steps of the first subscriber device Tg1 are additionally shown.

In the first step S10, the first subscriber device Tg1 sends a request to the second subscriber device Tg2, with which a call request is communicated. In this case, a desired conversation duration can also be transmitted with the call request and the corresponding complexity can be communicated. The request can be sent by the subscriber device 1 using an application (application, “app”) or other communication services (SMS, chat services, etc.). It is also possible to couple the subscriber device Tg1 with a personal computer, via which an email is sent to an account of the owner of the subscriber device 2.

In the following, however, it is assumed that corresponding applications (apps) are used in the subscriber device Tg1 and in the subscriber device Tg2.

The second subscriber device Tg2, presently considered as being separate from the motor vehicle, receives the request according to step S10 and then transmits a command in step S12 to a relevant control unit of the motor vehicle, which then begins collecting information in step S14 at the latest. The stress level of the driver is now being determined using a camera and/or a microphone provided as interior sensors. Furthermore, it is determined within the app of the subscriber device 2 which other calls are currently being made or at least scheduled by other passengers. Outdoor sensors (cameras, microphones, etc.) monitor traffic events, and information from outside the motor vehicle such as weather data, traffic data and the like is also determined, if necessary via the Internet, for which the subscriber device Tg2 can provide the connectivity. The driving situation complexity is now derived from all of this data, for which artificial intelligence can be used.

In step S16, the observed driving context and the current driving situation complexity are optionally stored in a backend, for example one with cross-user data storage. Technical approaches to implementing swarm intelligence include clustering or recommender algorithms, for example.

In step S18, the corresponding information is then transmitted from the motor vehicle to the second subscriber device Tg2. Alternatively, the information is processed directly in the control unit of the motor vehicle and in step S18a the indications are immediately transmitted as a result of the processing. In step S18b, the second subscriber device Tg2 transmits information about a possible call time or an interval in which a call can be started to the first subscriber device Tg1.

The actual call now takes place in step S20.

In step S22, the subscriber device Tg2 informs the motor vehicle that the call is underway, and in step S24 the motor vehicle takes over monitoring to further check the driving situation complexity.

In step S26a, corresponding information or the result of an evaluation thereof is transmitted to the second subscriber device Tg2, which causes the second subscriber device Tg2 to interrupt the call in step S26b, as an example. This is confirmed in step S28a by the first subscriber device Tg1, and in step S28b corresponding information is forwarded from the second subscriber device Tg2 to the motor vehicle.

In step S30, the motor vehicle now checks whether the complexity of the driving situation allows the conversation to be resumed. The information stored in step S16 can be taken into account in step S29.

In step S32, corresponding information or the result of an evaluation of such information is transmitted to the subscriber device Tg2, which initiates a resumption of the call to the first subscriber device Tg1 in step S24.

The conversation is then continued until the end of the conversation occurs in step S36 and in step S38 the second subscriber device Tg2 informs the control unit in the motor vehicle about this in order to completely end the procedure.

The following may also be of interest for scheduling:

If the caller specifies a desired period of time and wants to talk on the phone for around twenty minutes, then it may be that, due to the high complexity of the driving situation, no suitable period of time in which the conversation would be possible can be predicted for the person to be called. The second participant Tg2/the motor vehicle then proposes a shorter conversation duration (“five minutes”) and sends a corresponding message to the first participant device Tg1. The caller then has to decide whether this is sufficient and whether he wants to initiate or reject the call.

This manual step can be avoided if the caller can optionally specify a minimum conversation duration in addition to the desired conversation duration (desired period). The system (the second subscriber device Tg2/the motor vehicle) then informs about the possible length of the telephone call if this corresponds at least to the minimum conversation duration.

An additional optional solution consists in the further use of an intelligent system (AI algorithm) to which the caller can describe the intended conversation content, wherein the intelligent system itself decides or determines the minimum required or maximum required conversation duration to be assigned to the call. The caller would therefore avoid having to enter these parameters manually.

Overall, the examples show how a context-adapted call scheduler can be provided.

1. A method for organizing a conversation via mobile radio between a calling subscriber and a subscriber to be called, wherein the subscriber to be called is located in a motor vehicle, in particular as a vehicle driver, and wherein the calling subscriber uses a first subscriber device (Tg1) and the subscriber to be called uses a second subscriber device (Tg2), wherein the method comprises the following steps:
receiving a conversation request sent from the first subscriber device by the second subscriber device;
determining, by the motor vehicle, first information that is necessary to determine a current driving situation complexity and second information that is necessary to determine a future driving situation complexity;
using at least the second information and optionally also the first information to determine a possible call time or an interval in which a call can be started;
transmitting an indication about the possible call time or interval to a scheduling unit of the first subscriber device.

2. The method according to claim 1, wherein the motor vehicle transmits the first and the second information to the second subscriber device, in which a data processing device then carries out the step of using the at least second and optionally first information, and wherein the second subscriber device sends the indication wirelessly to the first subscriber device.

3. The method according to claim 1, wherein the second information relates to the driving situation complexity during a scheduled conversation duration.

4. The method according to claim 1, wherein an indication about a desired conversation duration is received with the conversation request and this information is also used in the step of using the at least second and optionally first information.

5. The method according to claim 4, wherein an indication of the actually possible conversation duration, which optionally includes the provision of interruptions, is transmitted to the scheduling unit of the first subscriber device.

6. The method according to claim 1, wherein an indication about a desired conversation duration is received with the conversation request and this indication is also used in the step of using the at least second and optionally first information.

7. The method according to claim 6, wherein the motor vehicle or the second subscriber device receives an input for setting a limit for the conversation complexity and this limit is taken into account for the setting.

8. The method according to claim 1, wherein the first information relates to a position of the motor vehicle, a traffic density around the motor vehicle, the familiarity of the route traveled by the subscriber to be called, a stress level of the subscriber to be called measured by interior sensors of the motor vehicle, data measured by external sensors, equipment features of the motor vehicle, the occupancy of seats in the motor vehicle and/or an indication about telephone calls made by other subscribers in the motor vehicle.

9. The method according to claim 1, wherein the second information relates to a navigation route provided by the motor vehicle, a traffic density on the navigation route and/or a traffic density on at least one alternative navigation route, an indication about other vehicle occupants and/or an indication about telephone calls made and/or scheduled by other vehicle occupants in the motor vehicle.

10. The method according to claim 1, wherein a call is made from the first subscriber device to the second subscriber device and it is continuously checked, in particular by the motor vehicle, whether the requirements for a conversation still exist, and corresponding indications are sent to the scheduling unit or to an output device of the first subscriber device.

11. A motor vehicle having sensors and an evaluation device for detecting a current driving situation complexity and a navigation device, wherein the evaluation device is designed to determine a future driving situation complexity based on navigation data in the navigation device and, depending on this, to schedule in advance the acceptance of a telephone call or video call.

12. The method according to claim 2, wherein the second information relates to the driving situation complexity during a scheduled conversation duration.

13. The method according to claim 2, wherein an indication about a desired conversation duration is received with the conversation request and this information is also used in the step of using the at least second and optionally first information.

14. The method according to claim 3, wherein an indication about a desired conversation duration is received with the conversation request and this information is also used in the step of using the at least second and optionally first information.

15. The method according to claim 2, wherein an indication about a desired conversation duration is received with the conversation request and this indication is also used in the step of using the at least second and optionally first information.

16. The method according to claim 3, wherein an indication about a desired conversation duration is received with the conversation request and this indication is also used in the step of using the at least second and optionally first information.

17. The method according to claim 4, wherein an indication about a desired conversation duration is received with the conversation request and this indication is also used in the step of using the at least second and optionally first information.

18. The method according to claim 5, wherein an indication about a desired conversation duration is received with the conversation request and this indication is also used in the step of using the at least second and optionally first information.

19. The method according to claim 2, wherein the first information relates to a position of the motor vehicle, a traffic density around the motor vehicle, the familiarity of the route traveled by the subscriber to be called, a stress level of the subscriber to be called measured by interior sensors of the motor vehicle, data measured by external sensors, equipment features of the motor vehicle, the occupancy of seats in the motor vehicle and/or an indication about telephone calls made by other subscribers in the motor vehicle.

20. The method according to claim 3, wherein the first information relates to a position of the motor vehicle, a traffic density around the motor vehicle, the familiarity of the route traveled by the subscriber to be called, a stress level of the subscriber to be called measured by interior sensors of the motor vehicle, data measured by external sensors, equipment features of the motor vehicle, the occupancy of seats in the motor vehicle and/or an indication about telephone calls made by other subscribers in the motor vehicle.
